(19) United States
(12) Patent Application Publication
(10) Pub. No.: US 2008/0205094 A1
(43) Pub. Date: Aug. 28, 2008

(54) Power Supply Unit for the Motor of a Magnetic Levitation Railway System

(76) Inventors: Uwe Henning, Erlangen (DE); Reinhard Hoffmann, Erlangen (DE); Jorg Lehmpfuhl, Erlangen (DE); Robert Schmid, Neunkirchen am Brand (DE); Wolfgang Spaeth, Zirndorf (DE); Benno Weis, Hemhofen (DE)

Correspondence Address: HARNESS, DICKEY & PIERCE, P.L.C., P.O.BOX 8910, RESTON, VA, 20195, US

(21) Appl. No.: 11/663,287

(22) PCT Filed: Sep. 16, 2005
(86) PCT No.: PCT/EP2005/054603

§ 371 Date: Oct. 5, 2007

(30) Foreign Application Priority Data
Sep. 21, 2004 (DE) 10 2004 046 325.5

(51) Int. Cl. H02M 5/458

(52) U.S. Cl. 363/37

(57) ABSTRACT

A power supply to the motor of a magnetic levitation railway system is provided with higher shut-off security which is comparably more economical and compact, and has a shorter shut-off time. As a result, a power supply device of at least one embodiment is provided with a frequency converter which is connected in a direct manner to an energy supply network with the input switching system. The frequency converter contains a rectifier which is arranged downstream from the input switching system, an intermediate circuit which is connected to the rectifier, an inverted rectifier end step which is arranged downstream from the intermediate circuit and which comprises an associated control device and an output switching system which is connected to the inverted rectifier end step and which is directly connected to the motor. The control input of the input switching system and the control input of the output switching system are connected to an operational control device which produces a shut-off command, and the intermediate circuit includes a short circuiter for the discharge thereof, the short circuiter being connected with the control input thereof to the operational control device.

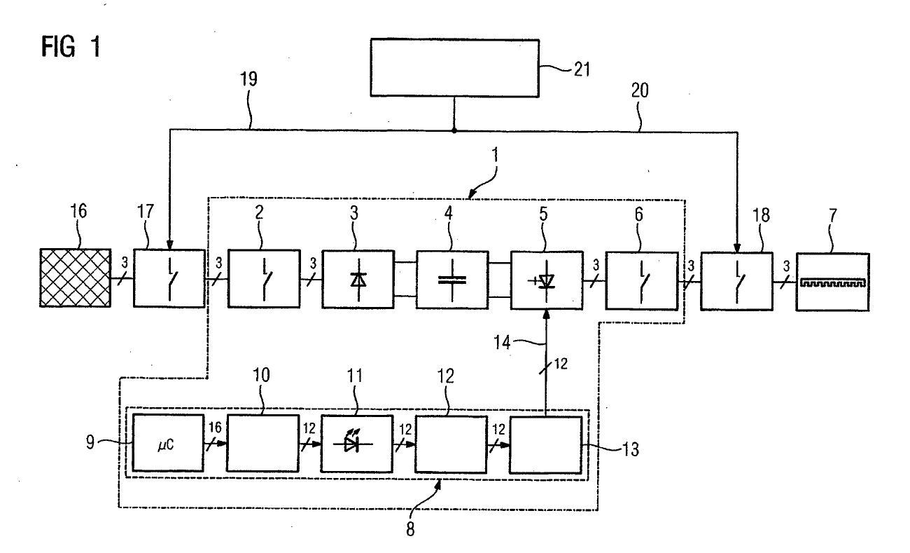

In a magnetic levitation railroad system of the TR08 or TR09 Transrapid type, the motor, which is in the form of a linear motor, is supplied with power via a frequency converter from a power supply system. As shown in FIG. 1, the frequency converter 1 has an input switchgear assembly 2 on the input side, which is followed by a rectifier 3. The rectifier 3 is connected to an intermediate circuit 4, which is followed by an inverter output stage 5. The output side of the inverter output stage 5 is connected to an output switchgear assembly 6 which is itself connected on the output side to the motor 7 for the magnetic levitation railroad system, which is otherwise not illustrated. As can also be seen from FIG. 1, the inverter output stage 5 of the frequency converter 1 is driven by means of a control device 8 which, on the input side, has a computation module 9 in the form of a microcontroller in order to produce drive pulses for the inverter output stage 5. The computation module 9 is followed by triggering equipment 10, whose output side is connected to twelve light-emitting diodes 11. These are in turn connected via galvanic isolation 12 by means of twelve optical waveguides to twelve gate units 13, each having an optical receiving diode, which is not illustrated. The inverter output stage 5 is driven at a predetermined frequency by the gate units 13 via twelve connecting lines 14.

Since there is a requirement in magnetic levitation railroad technology to be able to switch the electrical power supply device for the motor off with a high degree of safety, the frequency converter 1 in the known embodiment of the electrical power supply device is connected to a power supply system 16 via a safe input switching-off device 17, which comprises an arrangement of a plurality of mechanical circuit breakers arranged in such a manner that their redundant configuration complies with the required switch-off safety requirements. The stringent requirements for switch-off safety are satisfied by a further safe output switch-off device 18, designed in a corresponding manner to the input switch-off device, between the output of the frequency converter 1 and the motor 7, because both the safe input switch-off device 17 and the safe output switch-off device 18 are connected via connecting lines 19 and 20 to an operation control device 21 which, when required, emits a switch-off command to the safe switch-off devices 17 and 18, thus disconnecting the motor 7 from the frequency converter 1 and from the power supply system 16 with a high level of safety.

The invention is based on the object of further developing an electrical power supply device for the motor of a magnetic levitation railroad system such that, while maintaining a high level of switch-off safety, it can be produced at comparatively low cost and in a space-saving manner, while achieving a fast reaction time.

According to the invention, this object is achieved in an electrical power supply device for the windings of the motor of a magnetic levitation railroad system having a frequency converter which is connected on the input side by its input switchgear assembly directly to a power supply system and which contains a rectifier which is arranged downstream from the input switchgear assembly, an intermediate circuit which is connected to the rectifier, an inverter output stage which is arranged downstream from the intermediate circuit and has an associated control device, and an output switchgear assembly, which is connected to the inverter output stage and to which the electrical power supply system for the motor is directly connected, with the control input of the input switchgear assembly and the control input of the output switchgear assembly being connected to an output, which emits a switch-off command, of an operation control device, and the intermediate circuit has a short-circuiting device in order to discharge it, whose control input is connected to the output of the operation control device.

One major advantage of the electrical power supply device according to the invention is that it does not require a safe input switch-off device or a safe output switch-off device and therefore does not require any relatively expensive mechanical circuit breakers which, in addition, also require a relatively large amount of installation space and whose reaction times are comparatively slow. In this case, the safe-switching-off is achieved in that both the input switchgear assembly and the output switchgear assembly are switched off when required by a command from the operation control device and, at the same time, the intermediate circuit of the frequency converter is also switched off by discharging it. This is all done on the low-voltage side, thus making the design of the electrical power supply device according to the invention comparatively simple.

In order to further enhance the switch-off safety of the electrical power supply device according to the invention, it is advantageous if the control device in each case has a dedicated electrical power supply device for each of its individual active components, and at least one of the electrical power supply devices for the control device can be switched on and off by a connection between its control input and the output of the operation control device. This additionally increases the switch-off safety to a major extent, because the inverter output stage does not receive any control pulses, since these are not produced by the control device.

In addition, the switch-off safety can advantageously also be increased in that a computation module for calculation of nominal voltage values is connected as one of the active components of the control device by a control input to the output of the operation control device, in such a manner that the calculation of the nominal voltage values is stopped when a switch-off command occurs. This ensures that no nominal voltage values whatsoever are calculated by the computation module.

Furthermore, it is considered to be advantageous if triggering equipment for the control device is provided as a further active component with a switch-off input which is connected to the output of the operation control device.

Finally, it may also be advantageous in order to achieve a particularly high degree of switch-off safety if, the rectifier is a controlled rectifier, whose control input is connected to the output of the operation control device.

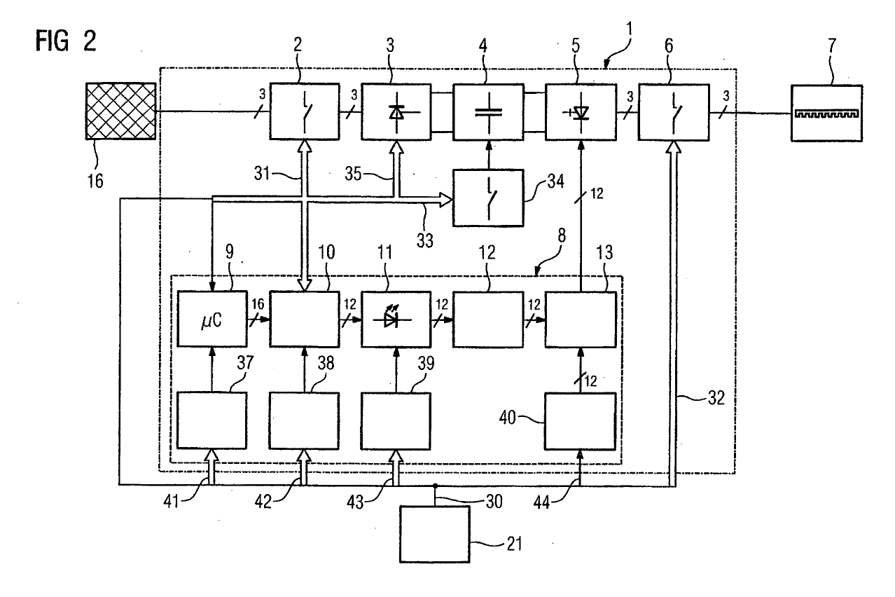

In order to explain the invention further, FIG. 2 shows one exemplary embodiment of an electrical power supply device according to the invention; in this case, elements which correspond to those shown in FIG. 1 are provided with the same reference symbols in FIG. 2.

As can be seen from FIG. 2, the input side of the frequency converter 1 is connected directly to the power supply system 16, and its output side is connected directly to the supply current (not illustrated) of the motor 7 of a magnetic levitation railroad system, which is not illustrated any further. The frequency converter 1 is connected to the operation control device 21 via a line 30 via which, when required, a switch-off command is emitted to the frequency converter 1.

As can be seen in detail in FIG. 2, the connecting line 30 is passed via a connection 31 to a control input, which is not shown in FIG. 2, of the input switchgear assembly 2, so that, when a switch-off command occurs, the operation control device 21 opens the input switchgear assembly 2. A control input, which is likewise not shown, of the output switchgear assembly 6 can be activated by the switch-off command from the operation control device 21 via a further connecting line 32, so that this output switchgear assembly opens when a switch-off command occurs, thus disconnecting the output side of the frequency converter 1 from the motor 7 and its supply system. A further connecting line 33 from the operation control device 21 is connected to a short-circuiting device 34 in the intermediate circuit 4, so that, when a switch-off command occurs, the operation control device 21 closes this short-circuiting device 34, thus discharging the intermediate circuit, which leads to its deactivation, thus further enhancing the switch-off safety. An initial connecting line 35 leads to the rectifier 3 and blocks it, which can be done in a simple manner in the case of a rectifier which is preferably completely or partially controlled.

In order to further enhance the switch-off safety, the active components of the control device 8, such as the computation module 9, the triggering equipment 10, the light-emitting diodes 11 and the gate units 13, are each provided with a voltage supply 37, 38, 39 and 40, respectively, to each of which the operation control device 21 can apply a switch-off command via a respective further connecting line 41, 42, 43 and 44 and via the connecting line 30, by which means these active components can be rendered completely or partially ineffective when a switch-off command occurs, thus leading to there being a high degree of safety that the gate device 13 will not drive the inverter output stage 5, thus additionally leading to an increase in the switch-off safety. This is true even when only one drive pulse or individual drive pulses are interrupted, because the motor 7 is a synchronous motor, in which the torque-forming component is then interfered with.

1. An electrical power supply device for the windings of the motor of a magnetic levitation railroad system, comprising:
a frequency converter, connected on the input side by its input switchgear assembly directly to a power supply system, the frequency converter including
a rectifier, arranged downstream from the input switchgear assembly,
an intermediate circuit, connected to the rectifier,
an inverter output stage, arranged downstream from the intermediate circuit and including an associated control device, and
an output switchgear assembly, connected to the inverter output stage and to which the supply system for the motor is directly connected,
the control input of the input switchgear assembly and the control input of the output switchgear assembly being connected to an output, which emits a switch-off command, of an operation control device, wherein
the intermediate circuit includes a short-circuiting device in order to discharge it, whose control input is connected to the output of the operation control device.

2. The electrical power supply device as claimed in claim 1, wherein the control device includes a dedicated electrical power supply device for each of its individual active components, and
at least one of the electrical power supply devices for the control device switchable on and off by a switch including a control input connected to the output of the operation control device.

3. The electrical power supply device as claimed in claim 1, wherein
a computation module for calculation of nominal voltage values is connected as one of the active components of the control device by a control input to the output of the operation control device, such that the calculation of the nominal voltage values is stopped when a switch-off command occurs.

4. The electrical power supply device as claimed in claim 1, wherein
triggering equipment for the control device is provided as a further active component with a switch-off input, connected to the output of the operation control device.

5. The electrical power supply device as claimed in claim 1, wherein
the rectifier is a controlled rectifier, whose control input is connected to the output of the operation control device.

6. The electrical power supply device as claimed in claim 2, wherein a computation module for calculation of nominal voltage values is connected as one of the active components of the control device by a control input to the output of the operation control device, such that the calculation of the nominal voltage values is stopped when a switch-off command occurs.

7. The electrical power supply device as claimed in claim 2, wherein triggering equipment for the control device is provided as a further active component with a switch-off input, connected to the output of the operation control device.

8. The electrical power supply device as claimed in claim 2, wherein the rectifier is a controlled rectifier, whose control input is connected to the output of the operation control device.
